(19) United States
(12) Patent Application Publication
(10) Pub. No.: US 2026/0149081 A1
(43) Pub. Date: May 28, 2026

(54) ENERGY STORAGE DEVICE

(71) Applicant: TOYOTA JIDOSHA KABUSHIKI KAISHA, Toyota-shi (JP)

(72) Inventors: Osamu YAMASHITA, Toyota-shi (JP); Shinichiro MORI, Nisshin-shi (JP); Koji SHIMIZU, Nagoya-shi (JP); Seigo FUJISHIMA, Miyoshi-shi (JP); Sumiko KITO, Nagoya-shi (JP); Shinya ISHIKAWA, Anjo-shi (JP); Shintaro TOMITA, Obu-shi (JP); Yuji YAMASHITA, Toyota-shi (JP); Kenta KIMURA, Nagoya-shi (JP)

(73) Assignee: TOYOTA JIDOSHA KABUSHIKI KAISHA, Toyota-shi (JP)

(21) Appl. No.: 19/351,695

(22) Filed: Oct. 7, 2025

(30) Foreign Application Priority Data
Nov. 26, 2024 (JP) 2024-205283

(51) Int. Cl. H01M 10/6557; H01M 10/613; H01M 10/617; H01M 10/625; H01M 10/658; H01M 50/204

(52) U.S. Cl. CPC H01M 10/6557; H01M 10/613; H01M 10/617; H01M 10/625; H01M 10/658; H01M 50/204

(57) ABSTRACT

An energy storage device includes a plurality of energy storage elements and a heat exchange plate. The heat exchange plate includes: a first member defining a first surface that faces a long side surface of one of the energy storage elements; a second member defining a second surface located opposite to the first surface; and a plurality of partition walls that define, between the first member and the second member, a channel configured to circulate a cooling medium. The partition walls include: a separating wall that divides the channel into a channel on the first member side and a channel on the second member side; and a separating wall that divides the channel in the width direction of the long side surface.

### CROSS-REFERENCE TO RELATED APPLICATION

This application claims priority to Japanese Patent Application No. 2024-205283 filed on Nov. 26, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

Various technologies related to energy storage devices have been proposed. For example, Japanese Unexamined Patent Application Publication No. 2023-123690 (JP 2023-123690 A) discloses a technique in which a heat exchanger is provided between energy storage elements constituting an energy storage device, which allows absorption of the expansion and contraction of the energy storage elements.

### SUMMARY

However, when a load is applied to the heat exchanger due to, for example, expansion or contraction of the energy storage elements, the heat exchanger may deform, which may impair its function as a heat exchanger.

The present disclosure has been made in view of the above issue, and an object thereof is to provide an energy storage device configured to maintain its function against a load acting on the heat exchanger.

An energy storage device according to one aspect of the present disclosure includes: a plurality of energy storage elements; and a heat exchanger disposed between the energy storage elements so as to face long side surfaces of the energy storage elements, and extending in a longitudinal direction of the long side surfaces. The heat exchanger includes: a first member including a first surface that faces the long side surface of one of the energy storage elements; a second member including a second surface that faces the energy storage element on an opposite side from the first surface; and a plurality of partition walls that define, between the first member and the second member, a channel configured to circulate a cooling medium. The partition walls include: a first partition wall provided between the first member and the second member and dividing the channel into a channel on the first member side and a channel on the second member side; and a second partition wall dividing the channel in the width direction of the long side surface.

In the above configuration, the heat exchanger is provided with the first partition wall. Therefore, the strength of the heat exchanger can be increased compared to a case where the heat exchanger is provided with the second partition wall alone. Accordingly, even when a load is applied to the heat exchanger due to, for example, contraction or expansion of the energy storage elements, deformation of the heat exchanger can be reduced, and the function as a heat exchanger can be maintained.

In one embodiment, the first partition wall is continuously provided from a first end to a second end of the heat exchanger in the longitudinal direction.

In the above configuration, the heat exchanger is provided with the first partition wall. Therefore, the strength of the heat exchanger can be increased compared to a case where the heat exchanger is provided with the second partition wall alone. Accordingly, even when a load is applied to the heat exchanger due to, for example, contraction or expansion of the energy storage elements, deformation of the heat exchanger can be reduced, and the function as a heat exchanger can be maintained.

In another embodiment, the first partition wall is continuously provided in a middle portion located between a first end and a second end of the heat exchanger in the longitudinal direction.

In this configuration, the pressure loss can be controlled by adjusting the length of the middle portion. It is therefore possible to achieve a desired cooling state such as uniformly cooling the energy storage elements by using the heat exchanger.

In still another embodiment, the first partition wall is continuously provided in a predetermined section extending from one of a first end and a second end of the heat exchanger in the longitudinal direction. The one of the first end and the second end is an end to which the cooling medium is supplied.

In this configuration, the pressure loss can be controlled by adjusting the length of the predetermined section. It is therefore possible to achieve a desired cooling state such as uniformly cooling the energy storage elements by using the heat exchanger.

In yet another embodiment, the heat exchanger includes a first heat exchanger including the first partition wall, and a second heat exchanger not including the first partition wall. The second heat exchanger is disposed downstream of the first heat exchanger in a direction of flow of the cooling medium.

With this configuration, it is possible to uniformly cool the energy storage elements that exchange heat with the first heat exchanger or the second heat exchanger.

The present disclosure can provide an energy storage device configured to maintain its function against a load acting on a heat exchanger.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a vehicle 1 equipped with an energy storage device 2;

FIG. 2 is an exploded perspective view of the energy storage device 2;

FIG. 3 is a plan view showing a cooling device 12 etc.;

FIG. 4 is a perspective view of the cooling device 12;

FIG. 5 shows an example of the configuration of a heat exchange plate 32; and

FIG. 6 shows an example of the configuration of a heat exchange plate 32A according to a modification.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

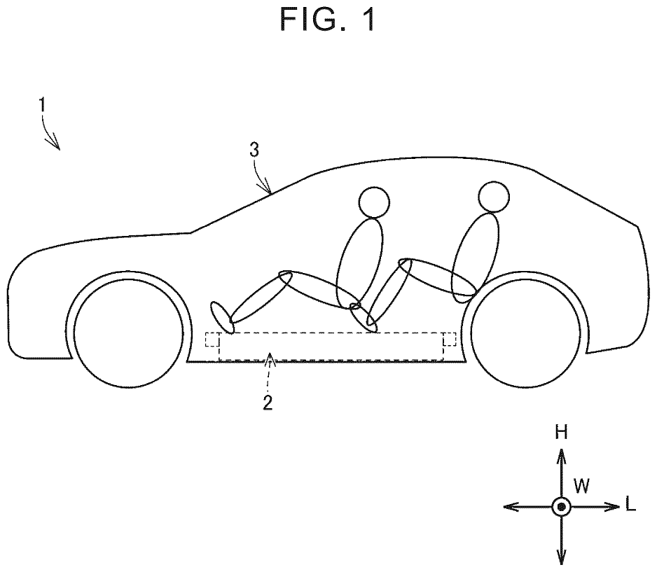

FIG. 1 schematically shows a vehicle 1 equipped with an energy storage device 2. The vehicle 1 includes a vehicle body 3, and the energy storage device 2 is mounted on the bottom of the vehicle body 3.

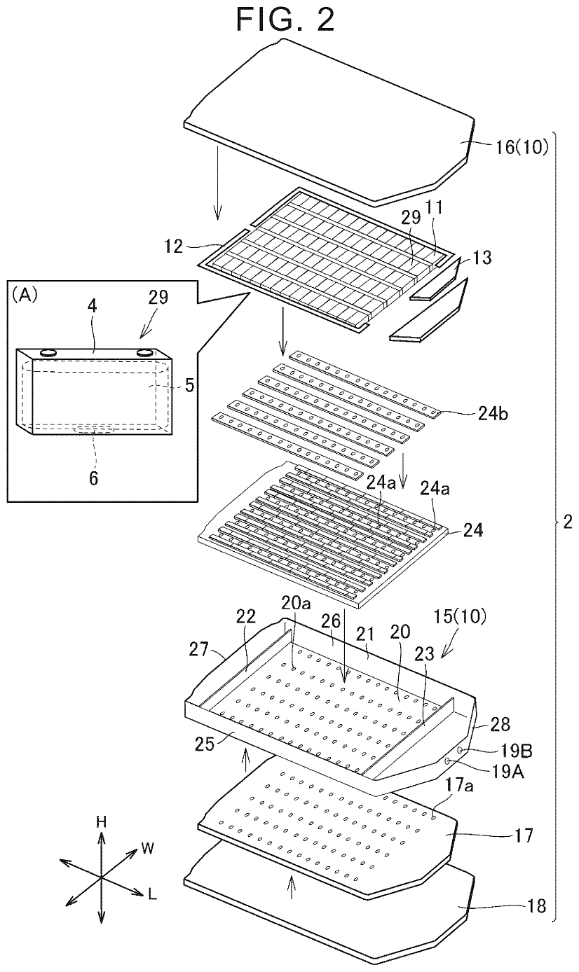

FIG. 2 is an exploded perspective view of the energy storage device 2. In FIG. 2, the width direction W refers to the width direction of the energy storage device 2 and also the width direction of the vehicle 1. The front-rear direction L refers to the front-rear direction of the energy storage device 2 and also the front-rear direction of the vehicle 1. The up-down direction H refers to the up-down direction of the energy storage device 2 and also the up-down direction of the vehicle 1.

The energy storage device 2 includes a housing case 10, an energy storage module 11, a cooling device 12, and an electrical device 13. The housing case 10 includes a lower case 15, an upper case 16, an insulating plate 17, and a share panel 18.

The lower case 15 is formed so as to open upward, and the upper case 16 is provided so as to close the opening of the lower case 15.

The lower case 15 includes a bottom plate 20, a peripheral wall 21, partition walls 22, 23, and an insulating plate 24.

The bottom plate 20 is in the form of a plate. The peripheral wall 21 is formed along the outer peripheral edge of the bottom plate 20. The peripheral wall 21 includes a side wall 25, a side wall 26, an end plate 27, and an end plate 28.

The side walls 25, 26 are arranged in the width direction W. The side walls 25, 26 are formed to extend in the front-rear direction L.

The end plates 27, 28 are spaced apart in the front-rear direction L. The end plates 27, 28 are formed to extend in the width direction W. The end plate 27 connects one end of the side wall 25 and one end of the side wall 26, and the end plate 28 connects the opposite end of the side wall 25 and the opposite end of the side wall 26.

Each of the side walls 25, 26 and the end plates 27, 28 is provided with a fixing portion that will be described later, and each of the fixing portions is fixed to the vehicle body 3.

The partition walls 22, 23 are disposed within a region surrounded by the bottom plate 20 and the peripheral wall 21. The partition wall 22 is disposed adjacent to the end plate 27, and is formed to extend in the width direction W.

The partition wall 23 is disposed at a distance from the end plate 28 in the front-rear direction L. The end plate 28 is also formed to extend in the width direction W.

Breathing membranes 19A, 19B are provided on the end plate 28. The breathing membranes 19A, 19B are waterproof, breathable membranes. The breathing membranes 19A, 19B are made of a material such as GORE-TEX.

The insulating plate 24 is disposed on a portion of the upper surface of the bottom plate 20 located between the partition walls 22, 23. The insulating plate 24 has a plurality of openings 24a. The insulating plate 24 is provided with an insulating protector 24b that closes the openings 24a.

The insulating plate 17 is fixed to the lower surface of the bottom plate 20, and the insulating plate 17 also has a plurality of openings 17a.

The bottom plate 20 also has a plurality of openings 20a. The openings 24a, the openings 20a, and the openings 17a are aligned in the up-down direction.

The share panel 18 is disposed under the insulating plate 17, and the outer peripheral edge of the share panel 18 is fixed to the lower surface of the bottom plate 20. The share panel 18 is formed to cover the insulating plate 17 and the lower surface of the bottom plate 20.

The energy storage module 11 is disposed on the upper surface of the insulating plate 24. The electrical device 13 is disposed between the partition wall 23 and the end plate 28.

The energy storage module 11 includes a plurality of energy storage cells 29. The energy storage cells 29 are arranged at intervals in the front-rear direction L and also arranged at intervals in the width direction W. Each of the energy storage cells 29 may be a nickel metal hydride cell or a lithium-ion cell, or may be an energy storage element such as a capacitor.

A perspective view of the energy storage cell 29 is shown in (A) of FIG. 2. The energy storage cell 29 includes a cell case 4 and an electrode assembly 5 housed in the cell case 4. The cell case 4 includes a bottom plate, and a vent valve 6 is formed in the bottom plate of the cell case 4. Each of the energy storage cells 29 is arranged such that its vent valve 6 is located above a corresponding one of the openings 24a of the insulating plate 24 shown in FIG. 2.

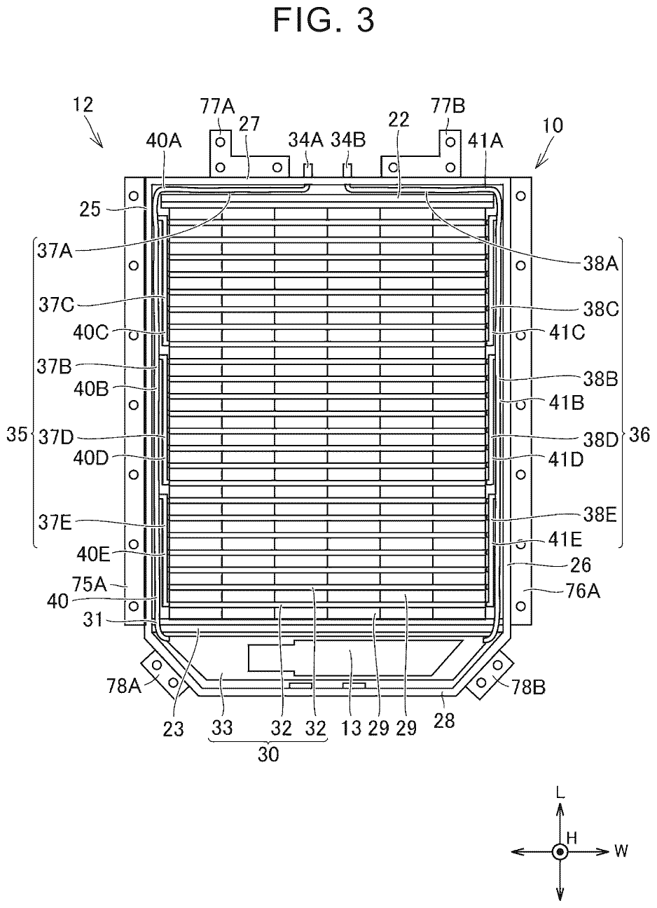

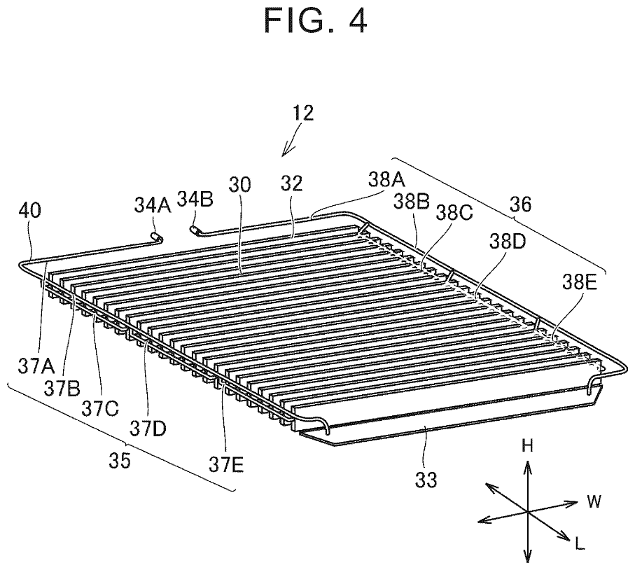

FIG. 3 is a plan view showing the cooling device 12 etc., and FIG. 4 is a perspective view of the cooling device 12. The energy storage cells 29 etc. are not shown in FIG. 4.

Referring to FIGS. 3 and 4, the cooling device 12 includes a heat exchanger 30, a cooling medium pipe 31, and a thermal insulating member 40. The heat exchanger 30 includes a plurality of heat exchange plates 32 and a heat exchange plate 33.

The heat exchange plates 32 are arranged at intervals in the front-rear direction L. Each of the heat exchange plates 32 is disposed to extend in the width direction W. Multiple energy storage cells 29 arranged in the width direction W are disposed between the heat exchange plates 32 adjacent to each other in the front-rear direction L.

The cooling medium pipe 31 is disposed in the housing case 10. The cooling medium pipe 31 includes a supply pipe 35 and a discharge pipe 36.

The supply pipe 35 is connected to a supply portion 34A. The supply portion 34A is inserted into an insertion hole 39A formed in the end plate 27, and is fixed to the end plate 27.

The supply pipe 35 includes a main supply pipe 37A, a main supply pipe 37B, and branch pipes 37C, 37D, 37E.

The main supply pipe 37A is disposed between the partition wall 22 and the end plate 27, and is arranged to extend in the width direction W. The main supply pipe 37A is formed to extend toward the side wall 25.

The main supply pipe 37B is connected to an end of the main supply pipe 37A, and is formed to extend in the front-rear direction L along the side wall 25.

Each of the branch pipes 37C, 37D, 37E is disposed below the main supply pipe 37B, and is connected to the main supply pipe 37B. The branch pipes 37C, 37D, 37E are arranged at intervals in the front-rear direction L.

The connection portions between the main supply pipe 37B and each of the branch pipes 37C, 37D, 37E are provided at intervals in the front-rear direction L.

Multiple heat exchange plates 32 arranged at intervals in the front-rear direction L are connected to the branch pipe 37C. Similarly, multiple heat exchange plates 32 arranged at intervals in the front-rear direction L are connected to the branch pipe 37D, and multiple heat exchange plates 32 arranged at intervals in the front-rear direction L are connected to the branch pipe 37E.

The heat exchange plate 33 is connected to the end of the main supply pipe 37B on the end plate 28 side. The heat exchange plate 33 is disposed on a portion of the upper surface of the bottom plate 20 located between the partition wall 23 and the end plate 28. An insulating plate is disposed between the heat exchange plate 33 and the bottom plate 20. The electrical device 13 is disposed on the upper surface of the heat exchange plate 33. The electrical device 13 includes, for example, a battery electronic control unit (ECU) and a junction box.

The discharge pipe 36 includes a main discharge pipe 38A, a main discharge pipe 38B, and branch pipes 38C, 38D, 38E.

The discharge pipe 36 is connected to a discharge portion 34B. The discharge portion 34B is inserted into an insertion hole 39B formed in the end plate 27, and is fixed to the end plate 27. The insertion holes 39A, 39B are formed spaced apart from each other in the width direction W.

The main discharge pipe 38A is disposed between the partition wall 22 and the end plate 27. The main discharge pipe 38A is arranged to extend in the width direction W, and is formed to extend toward the side wall 26.

The main discharge pipe 38B is connected to an end of the main discharge pipe 38A, and is formed to extend along the side wall 26.

Each of the branch pipes 38C, 38D, 38E is disposed below the main discharge pipe 38B, and is connected to the main discharge pipe 38B. The branch pipes 38C, 38D, 38E are arranged at intervals in the front-rear direction L.

Multiple heat exchange plates 32 arranged at intervals in the front-rear direction L are connected to the branch pipe 38C. Similarly, multiple heat exchange plates 32 arranged at intervals in the front-rear direction L are connected to the branch pipe 38D, and multiple heat exchange plates 32 arranged at intervals in the front-rear direction L are connected to the branch pipe 38E. The heat exchange plate 33 is connected to the end of the main discharge pipe 38B on the end plate 28 side.

The thermal insulating member 40 includes thermal insulating members 40A, 40B, 40C, 40D, 40E, and thermal insulating members 41A, 41B, 41C, 41D, 41E.

The thermal insulating member 40A covers the main supply pipe 37A. The thermal insulating member 40B covers the main supply pipe 37B. Similarly, the thermal insulating members 40C, 40D, 40E cover the branch pipes 37C, 37D, 37E, respectively. The thermal insulating members 41A, 41B cover the main discharge pipes 38A, 38B, respectively. The thermal insulating members 41C, 41D, 41E cover the branch pipes 38C, 38D, 38E, respectively.

As shown in FIG. 3, a fixing portion 75A is formed on the outer surface of the side wall 25. Similarly, a fixing portion 76A is formed on the outer surface of the side wall 26.

Fixing portions 77A, 77B are formed on the outer surface of the end plate 27, and fixing portions 78A, 78B are formed on the outer surface of the end plate 28.

The fixing portions 77A, 77B are fixed to the vehicle body 3 by fastening members. For example, the vehicle body 3 includes side sills arranged spaced apart from each other in the width direction W, a cross member connecting the side sills, and a floor panel. The fixing portions 77A, 77B are fixed to the cross member. The fixing portions 77A, 77B may alternatively be fixed to the floor panel.

The fixing portion 75A is formed so as to protrude in the width direction W from the outer surface of the side wall 25. The fixing portion 76A is formed so as to protrude in the width direction W from the outer surface of the side wall 26. The fixing portion 75A is fixed to one of the side sills of the vehicle body 3 by fastening members, and the fixing portion 76A is fixed to the other side sill of the vehicle body 3 by fastening members.

The energy storage device 2 configured as above will now be described. Referring to FIG. 2, when the energy storage module 11 is cooled, a cooling medium C is supplied to the cooling device 12. Referring to FIG. 3, the cooling medium C is supplied from the supply portion 34A into the supply pipe 35. Specifically, the cooling medium C is supplied into the main supply pipe 37A. The cooling medium C then enters the main supply pipe 37B. Part of the cooling medium C introduced into the main supply pipe 37B enters the branch pipes 37C, 37D, 37E.

The cooling medium C introduced into the branch pipe 37C is supplied to the multiple heat exchange plates 32 connected to the branch pipe 37C. Similarly, the cooling medium C introduced into the branch pipe 37D is supplied to the multiple heat exchange plates 32 connected to the branch pipe 37D. The cooling medium C introduced into the branch pipe 37E is supplied to the multiple heat exchange plates 32 connected to the branch pipe 37E.

The cooling medium C is thus supplied to the heat exchange plates 32, whereby the energy storage cells 29 arranged between the heat exchange plates 32 are cooled. On the other hand, the cooling medium C flowing through the heat exchange plates 32 is heated by heat from the energy storage cells 29.

The heat exchange plates 32 are connected to the branch pipes 38C, 38D, 38E, and the cooling medium C heated in the heat exchange plates 32 flows into the branch pipes 38C, 38D, 38E.

The branch pipes 38C, 38D, 38E are connected to the main discharge pipe 38B. The cooling medium C passes through the main discharge pipes 38B, 38A and is then discharged to the outside of the housing case 10 from the discharge portion 34B. The discharge portion 34B is connected to a radiator, not shown, etc., and the cooling medium C is cooled by the radiator etc. The cooling medium C thus cooled is then supplied again to the supply portion 34A.

The heat exchange plate 33 is connected to the end of the main supply pipe 37B, and the electrical device 13 is cooled by the heat exchange plate 33. The heat exchange plate 33 is connected to the end of the main discharge pipe 38B, and the cooling medium C flowing through the heat exchange plate 33 enters the main discharge pipe 38B.

Each of the heat exchange plates 32 is disposed between the energy storage cells 29 so as to face the side surfaces in the longitudinal direction (width direction W) (hereinafter referred to as “long side surfaces”) of the energy storage cells 29. The heat exchange plates 32 are provided to extend in the longitudinal direction (width direction W) of the long side surfaces of the energy storage cells 29.

In the energy storage device 2 configured as described above, when a load is applied to the heat exchange plate 32 due to, for example, expansion or contraction of the energy storage cells 29, the heat exchange plate 32 may deform, which may impair its function as a heat exchanger.

In view of this, in the present embodiment, the heat exchange plate 32 is configured as follows. The heat exchange plate 32 includes: a first member defining a first surface that faces a long side surface of one of the energy storage cells 29; a second member defining a second surface located opposite to the first surface; and a plurality of partition walls that define, between the first member and the second member, a channel configured to circulate a cooling medium. The partition walls include: a first partition wall provided between the first member and the second member and dividing the channel into a channel on the first member side and a channel on the second member side; and a second partition wall dividing the channel in the width direction of the long side surface.

In the above configuration, the heat exchange plate 32 is provided with the first partition wall. Therefore, the strength of the heat exchange plate 32 can be increased compared to a case where the heat exchange plate 32 is provided with the second partition wall alone. Therefore, even when a load is applied to the heat exchange plate 32 due to, for example, contraction or expansion of the energy storage cells 29, deformation of the heat exchange plate 32 can be reduced, and the function as a heat exchanger can be maintained.

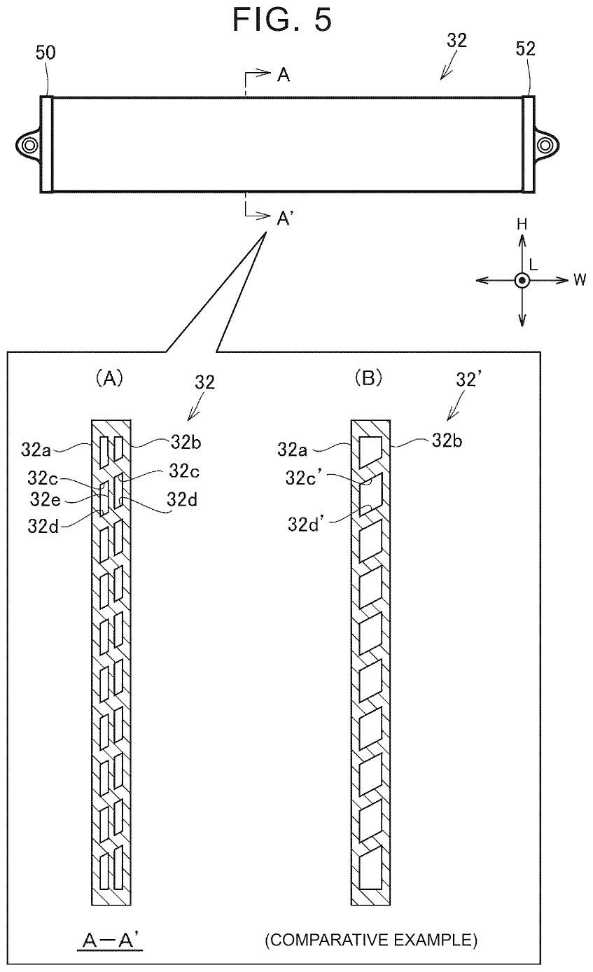

A specific configuration of the heat exchange plate 32 of the energy storage device 2 according to the present embodiment will be described with reference to FIG. 5.

FIG. 5 shows an example of the configuration of the heat exchange plate 32. As shown in FIG. 5, the heat exchange plate 32 has a rectangular shape as viewed from the front-rear direction L. The heat exchange plate 32 has a hollow internal structure. A plurality of separating walls (partition walls) is provided inside the heat exchange plate 32. A plurality of cooling medium channels is formed inside the heat exchange plate 32 by the separating walls. A connection portion 50 that is connected to the supply pipe 35 is provided at one end of the heat exchange plate 32 in the width direction W. A connection portion 52 that is connected to the discharge pipe 36 is provided at the other end of the heat exchange plate 32 in the width direction W. Therefore, the cooling medium supplied from the connection portion 50 with the supply pipe 35 flows through the channels inside the heat exchange plate 32 from one end to the other end. The cooling medium is then discharged from the connection portion 52 to the discharge pipe 36.

The heat exchange plate 32 is made of, for example, a highly thermally conductive metal such as aluminum, or a resin. The heat exchange plate 32 is manufactured by attaching the connection portions 50, 52 to a hollow aluminum member formed by, for example, extrusion.

An example of a cross-section of the heat exchange plate 32 is shown in (A) of FIG. 5. A cross-section of the heat exchange plate 32 taken along line A-A′ is shown in (A) of FIG. 5. As shown in (A) of FIG. 5, the heat exchange plate 32 includes a first member 32a and a second member 32b. The first member 32a defines a first surface that faces the long side surfaces of the energy storage cells 29 on one side in the front-to-rear direction L. The second member 32b defines a second surface located opposite to the first surface. The second member 32b faces the long side surfaces of the energy storage cells 29 on the other side. A plurality of channels is formed inside the heat exchange plate 32 by a plurality of separating walls including separating walls 32c, 32d, and a separating wall 32e. The separating walls including the separating walls 32c, 32d are walls formed along parallel planes connecting the first member 32a and the second member 32b. The separating wall 32e is a wall formed along a plane parallel to a plane defined by the up-down direction H and the width direction W. The separating wall 32e corresponds to the “first partition wall,” and the separating walls 32c, 32d correspond to the “second partition wall.”

The configuration of a heat exchange plate 32′ is shown as a comparative example in (B) of FIG. 5. In the heat exchange plate 32′, a plurality of channels is formed by the first member 32a, the second member 32b, and separating walls 32c′, 32d′. The surface that forms the separating wall 32c′ and the surface that forms the separating wall 32d′ are parallel to each other. The heat exchange plate 32 has a configuration obtained by adding a separating wall, namely a wall that separates a plurality of channels along a plane parallel to a plane defined by the up-down direction H and the width direction W, to the heat exchange plate 32′ in (B) of FIG. 5. The separating wall 32e that divides the channel of the heat exchange plate 32 into a first channel on the first member 32a side and a second channel on the second member 32b side may be configured to divide the channel into the first and second channels such that the first and second channels have the same cross-sectional area, or may be configured to divide the channel into the first and second channels such that the first and second channels have different cross-sectional areas.

In the present embodiment, the heat exchange plate 32 is configured to have the cross-section in (A) of FIG. 5 continuously from a first end to a second end of the heat exchange plate 32 in the width direction W.

When the energy storage cell 29 is charged or discharged, the energy storage cell 29 expands or contracts. For example, when the energy storage cell 29 expands, a force acts on the heat exchange plate 32 so as to compress the heat exchange plate 32 in the front-rear direction L. By providing the separating wall 32e in addition to the separating walls (including the separating walls 32c, 32d) that connect the first and second members 32a, 32b, the strength of the heat exchange plate 32 against such a force is increased, compared to a case where the separating wall 32e is not provided. Accordingly, plastic deformation of the heat exchange plate 32 is reduced, and the channel area is maintained, thereby allowing the flow of the cooling medium to be maintained. When the energy storage cell 29 subsequently contracts, a force acts on the heat exchange plate 32 in a direction in which the first member 32a and the second member 32b move away from each other. Even in this case, by providing the separating wall 32e in addition to the separating walls that connect the first and second members 32a, 32b, the strength of the heat exchange plate 32 is increased, compared to the case where the separating wall 32e is not provided. Accordingly, plastic deformation of the heat exchange plate 32 is reduced. Even when a load is applied to the heat exchange plate 32 due to, for example, expansion or contraction of the energy storage cells 29, the function as a heat exchanger is thus maintained.

As described above, in the energy storage device 2 of the present embodiment, the strength of the heat exchange plate 32 can be increased by providing the separating wall 32e, compared to the case where the separating wall 32e is not provided (the heat exchange plate 32′ of the comparative example). Therefore, even when a load is applied to the heat exchange plate 32 due to, for example, contraction or expansion of the energy storage cells 29, deformation of the heat exchange plate 32 can be reduced, and the function as a heat exchanger can be maintained. Accordingly, it is possible to provide an energy storage device configured to maintain its function against a load acting on a heat exchanger.

Modifications will now be described. The above embodiment illustrates an example in which the separating wall 32e is provided from the first end to the second end of the heat exchange plate 32 in the width direction. However, the present disclosure is not particularly limited to such a configuration. For example, a configuration may be adopted in which the separating wall 32e is provided in a partial section extending from the first end toward the second end of the heat exchange plate 32 in the width direction W, and is not provided in other sections.

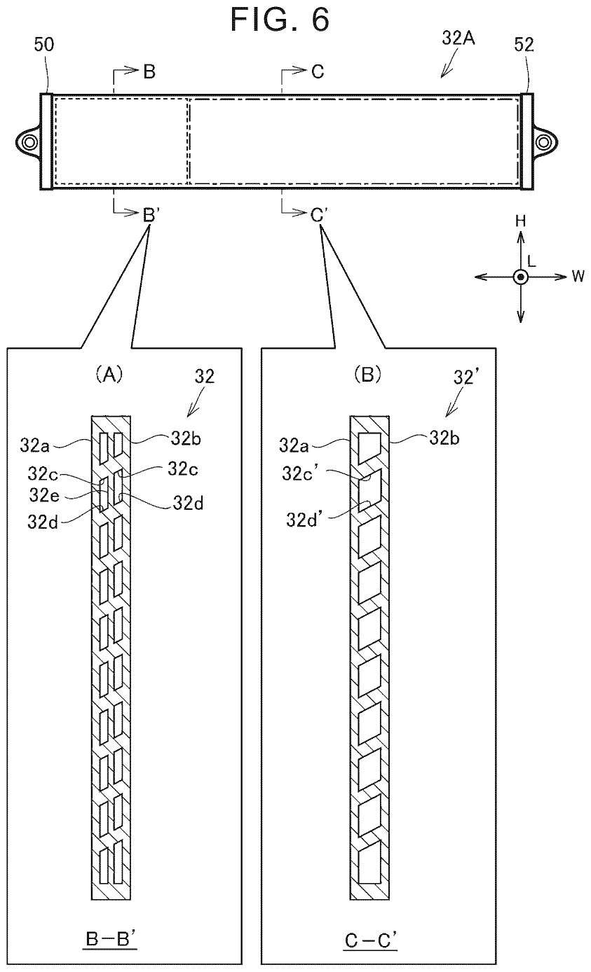

FIG. 6 shows an example of the configuration of a heat exchange plate 32A according to a modification. The heat exchange plate 32A shown in FIG. 6 is different from the heat exchange plate 32 shown in FIG. 5 in that the section enclosed by the dashed line has the same cross-section as that in (A) of FIG. 5, and the section enclosed by the long dashed short dashed line has the same cross-section as that in (B) of FIG. 5. Since the components in FIG. 6, including those in (A) and (B) of FIG. 6, are otherwise the same as the components in FIG. 5 (including those in (A) and (B) of FIG. 5), detailed description thereof will not be repeated.

As shown in FIG. 6, in the heat exchange plate 32A, a cross-sectional structure shown in (A) of FIG. 6 is provided in a section extending from the first end (connection portion 50), namely the end to which the cooling medium is supplied, to a position located at a predetermined distance from the end in the width direction W, and a cross-sectional structure shown in (B) of FIG. 6 is provided in the remaining section.

This configuration can increase the strength in the section having the cross-sectional structure shown in (A) of FIG. 6. Moreover, in the heat exchange plate 32, the pressure loss in the channels in the section enclosed by the dashed line can be controlled by adjusting the distance over which the cross-sectional structure shown in (A) of FIG. 6 is provided. Accordingly, the flow velocity and flow rate of the cooling medium can be adjusted for each heat exchange plate 32A. The energy storage cells 29 can be uniformly cooled by adjusting the distance over which the cross-sectional structure shown in (A) of FIG. 6 is provided in each heat exchange plate 32A. This can reduce variations in cooling within the energy storage module 11.

The region in which the cross-sectional structure shown in (A) of FIG. 6 is provided is not limited to the section enclosed by the dashed line in FIG. 6. The cross-sectional structure shown in (A) of FIG. 6 may be provided in the section enclosed by the long dashed short dashed line (i.e., on the connection portion 52 side), or may be provided in a middle portion of the heat exchange plate 32A. This can also reduce variations in cooling within the energy storage module 11.

The above embodiment illustrates an example in which each of the heat exchange plates 32 has the cross-section shown in (A) of FIG. 5. However, the present disclosure is not particularly limited to such a configuration. For example, among the heat exchange plates 32 arranged in the front-rear direction L, some heat exchange plates may be configured as first heat exchange plates having the cross-section shown in (A) of FIG. 5, and the remaining heat exchange plates may be configured as second heat exchange plates having the cross-section shown in (B) of FIG. 5. The second heat exchange plates may be arranged downstream of the first heat exchange plates in the direction of flow of the cooling medium.

For example, among the heat exchange plates, some predetermined heat exchange plates located at a short flow distance of the cooling medium from the main supply pipe 37A (or the main supply pipe 37B) may be configured as heat exchange plates having the cross-section shown in (A) of FIG. 5, and other heat exchange plates located at a long flow distance of the cooling medium from the main supply pipe 37A may be configured as heat exchange plates having the cross-section shown in (B) of FIG. 5.

Accordingly, the energy storage cells 29 can be uniformly cooled by adjusting the number of heat exchange plates having the cross-section shown in (A) of FIG. 5. This can reduce variations in cooling within the energy storage module 11.

All or part of the modifications described above may be combined as appropriate. The embodiment disclosed herein should be considered to be illustrative in all respects and not restrictive. The scope of the present disclosure is set forth in the claims rather than in the above description, and is intended to include all modifications within the meaning and scope equivalent to the claims.

What is claimed is:

1. An energy storage device comprising:
a plurality of energy storage elements; and
a heat exchanger disposed between the energy storage elements so as to face long side surfaces of the energy storage elements, and extending in a longitudinal direction of the long side surfaces, wherein:
the heat exchanger includes
a first member including a first surface that faces the long side surface of one of the energy storage elements,
a second member including a second surface that faces the energy storage element on an opposite side from the first surface, and
a plurality of partition walls that define, between the first member and the second member, a channel configured to circulate a cooling medium; and
the partition walls include
a first partition wall provided between the first member and the second member and dividing the channel into a channel on a first member side and a channel on a second member side, and
a second partition wall dividing the channel in a width direction of the long side surface.

2. The energy storage device according to claim 1, wherein the first partition wall is continuously provided from a first end to a second end of the heat exchanger in the longitudinal direction.

3. The energy storage device according to claim 1, wherein the first partition wall is continuously provided in a middle portion located between a first end and a second end of the heat exchanger in the longitudinal direction.

4. The energy storage device according to claim 1, wherein the first partition wall is continuously provided in a predetermined section extending from one of a first end and a second end of the heat exchanger in the longitudinal direction, the one of the first end and the second end being an end to which the cooling medium is supplied.

5. The energy storage device according to claim 1, wherein:
the heat exchanger includes a first heat exchanger including the first partition wall, and a second heat exchanger not including the first partition wall; and
the second heat exchanger is disposed downstream of the first heat exchanger in a direction of flow of the cooling medium.
